(19) United States
(12) Patent Application Publication
(10) Pub. No.: US 2013/0147932 A1
(43) Pub. Date: Jun. 13, 2013

(54) STEREOSCOPIC VIDEO DISPLAY APPARATUS AND STEREOSCOPIC VIDEO DISPLAY METHOD

(71) Applicants: Masayuki Tokunaga, Tokyo (JP); Tatsuo Saishu, Tokyo (JP)

(72) Inventors: Masayuki Tokunaga, Tokyo (JP); Tatsuo Saishu, Tokyo (JP)

(21) Appl. No.: 13/468,735

(22) Filed: May 10, 2012

(30) Foreign Application Priority Data
Dec. 7, 2011 (JP) 2011-267615

(51) Int. Cl. H04N 13/04

(52) U.S. Cl. 348/59; 348/51; 348/E13.026

(57) ABSTRACT

A stereoscopic video display apparatus according to an embodiment includes: a plane display device having a display face in which a first pixel and a second pixel having an equal area and different shapes are arranged alternately in a row direction and a column direction; an optical plate disposed in front of the display face of the plane display device; a video generation unit generating a video for stereoscopic image display and a video for two-dimensional image display from a video signal; and a luminance control unit changing luminance values of the first and second pixels which are adjacent to each other when displaying the video generated and exercising control to cause an average luminance of the first pixel and the second pixel before the change and an average luminance of the first pixel and the second pixel after the change to become equal to each other.

### CROSS-REFERENCE TO RELATED APPLICATION

This application is based upon and claims the benefit of priority from prior Japanese Patent Application No. 2011-267615 filed on Dec. 7, 2011 in Japan, the entire contents of which are incorporated herein by reference.

### FIELD

Embodiments described herein relate generally to a stereoscopic video display apparatus and a stereoscopic video display method.

### BACKGROUND

An autostereoscopic video display apparatus (without glasses) is developed. The autostereoscopic video display apparatus includes a plane display unit having a screen on which pixels are arranged in a matrix form, and a lenticular sheet which is provided in front of the screen of the plane display unit and can refract light rays from the pixels. The lenticular sheet has a configuration in which a plurality of cylindrical lenses are arranged in parallel in a direction perpendicular to their lengthwise direction.

In the autostereoscopic video display apparatus, it is conducted to dispose the lenticular sheet to be inclined with respect to a longitudinal direction of the screen of the plane display device in order to prevent an image from being degraded, especially prevent an image from being degraded by moiré.

Furthermore, a technique of suppressing image unevenness in the autostereoscopic video display apparatus by arranging a plurality of display elements including a first pixel which displays an image for a first viewpoint and a second pixel which displays an image for a second viewpoint and disposing reflection display regions which reflect external light respectively of the first and second pixels unsymmetrically about an axis perpendicular to an image distribution direction is known.

In the autostereoscopic video display apparatus using a lenticular sheet, however, a technique capable of reducing degradation of the display quality, especially influence of color unevenness is unknown.

### BRIEF DESCRIPTION OF THE DRAWINGS

FIG. 1 is a diagram showing a stereoscopic video display apparatus according to a first embodiment;

FIGS. 2(a) and 2(b) are diagrams showing examples of an optical plate according to the first embodiment;

FIG. 3 is a diagram showing the stereoscopic video display apparatus according to the first embodiment;

FIGS. 4(a) and 4(b) are diagrams showing a first concrete example of pixels which have an equal area and a different shape;

FIGS. 5(a) and 5(b) are diagrams showing a second concrete example of pixels which have an equal area and a different shape;

FIG. 6 is a diagram showing an example of distribution of a luminance difference between a first pixel and a second pixel after a change;

FIG. 7 is a diagram showing another example of distribution of a luminance difference between the first pixel and the second pixel after the change; and

FIGS. 8(a) and 8(b) are diagrams showing examples of an optical plate used in a stereoscopic video display apparatus according to a second embodiment.

### DETAILED DESCRIPTION OF THE INVENTION

A stereoscopic video display apparatus according to an embodiment includes: a plane display device having a display face in which a first pixel and a second pixel having an equal area and different shapes are arranged alternately in a row direction and a column direction; an optical plate disposed in front of the display face of the plane display device to control directions of light rays illuminated from the plane display device; a video generation unit configured to generate a video for stereoscopic image display and a video for two-dimensional image display from a video signal which is input; and a luminance control unit configured to change luminance values of the first and second pixels which are adjacent to each other when displaying the video generated by the video generation unit and exercise control to cause an average luminance of the first pixel and the second pixel before the change and an average luminance of the first pixel and the second pixel after the change to become equal to each other.

Hereafter, embodiments will be described with reference to the drawings.

### First Embodiment

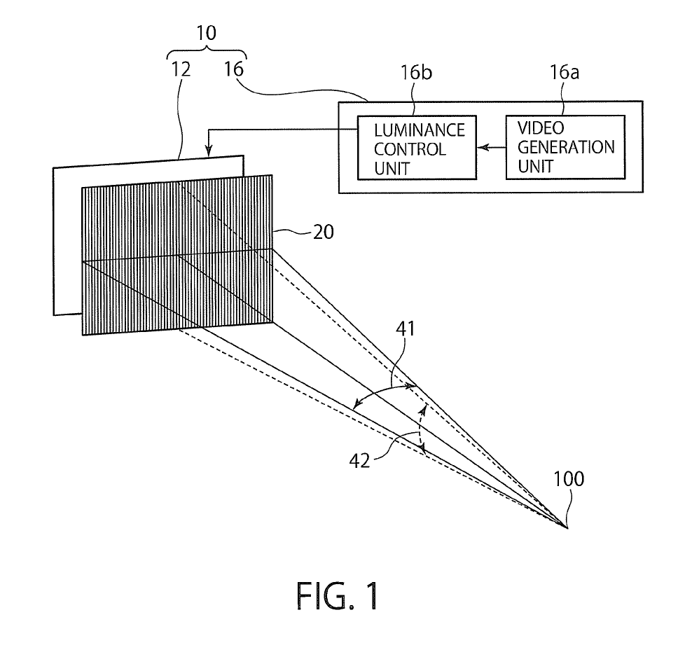

A stereoscopic video display apparatus according to a first embodiment will now be described with reference to the drawings. First, FIG. 1 shows a configuration of a stereoscopic video display apparatus according to the first embodiment. The stereoscopic video display apparatus according to the first embodiment includes a plane display device 10 formed of a plane display unit (referred to as display panel as well) 12 having a display screen on which pixels are arranged in a matrix form, and a drive unit 16 which drives the plane display unit 12, and an optical plate 20 having optical aperture portions provided in front of the plane display unit 12 to control light rays emitted from the pixels in the plane display unit 12. It becomes possible to view a stereoscopic image in front of and behind the optical plate 20 by viewing light rays illuminated from the plane display unit 12 via the optical plate 20 from a viewer's eye position 100, in a range of a viewing angle 41 in a horizontal direction and a viewing angle 42 in a vertical direction. By the way, in the case where the optical plate is a slit, the optical aperture portions are physical aperture portions. In the case of a lenticular sheet, the optical aperture portions are cylindrical lenses. In this case, there is parallax only in the horizontal direction 41 and an image changes according to the viewing distance. In the vertical direction 42, however, there is no parallax and consequently a predetermined video is visually recognized regardless of the viewing position. By the way, a spacer is provided in some cases between the plane display unit 12 and the optical plate 20 to adjust the focal length. The optical plate 20 is, for example, a lenticular sheet and it may have a configuration in which the refractive index of each cylindrical lens is varied by an external control signal. In this case, it becomes possible to display a stereoscopic video or a two-dimensional video by controlling the refractive indexes of the lenses included in the optical plate 20.

The plane display unit 12 can be a display panel such as a liquid crystal display device, a plasma display device, a field emission type display device, or an organic EL display device of direct view type or projection type as long as pixels determined in position in the display screen are arranged in a matrix form in a plane. Furthermore, the drive unit 16 sends display data to the plane display unit 12, assigns the display data to the pixels in the plane display unit 12, and drives the stereoscopic video display apparatus to display a stereoscopic video. The drive unit 16 can be integrated with the plane display unit 12 or can be provided externally to the plane display unit 12.

In the present embodiment, the drive unit 16 includes a video generation unit 16a and a luminance control unit 16b. The video generation unit 16a generates a video depending upon whether the video displayed by the plane display device 10 is a stereoscopic video or a two-dimensional video, from a video signal which is input from the external. By the way, the video generation unit 16a can generate a moving picture or a still picture such as, for example, PEG (Joint Photographic Experts Group). The luminance control unit 16b controls luminance of a video generated by the video generation unit 16a. This control of the luminance will be described later.

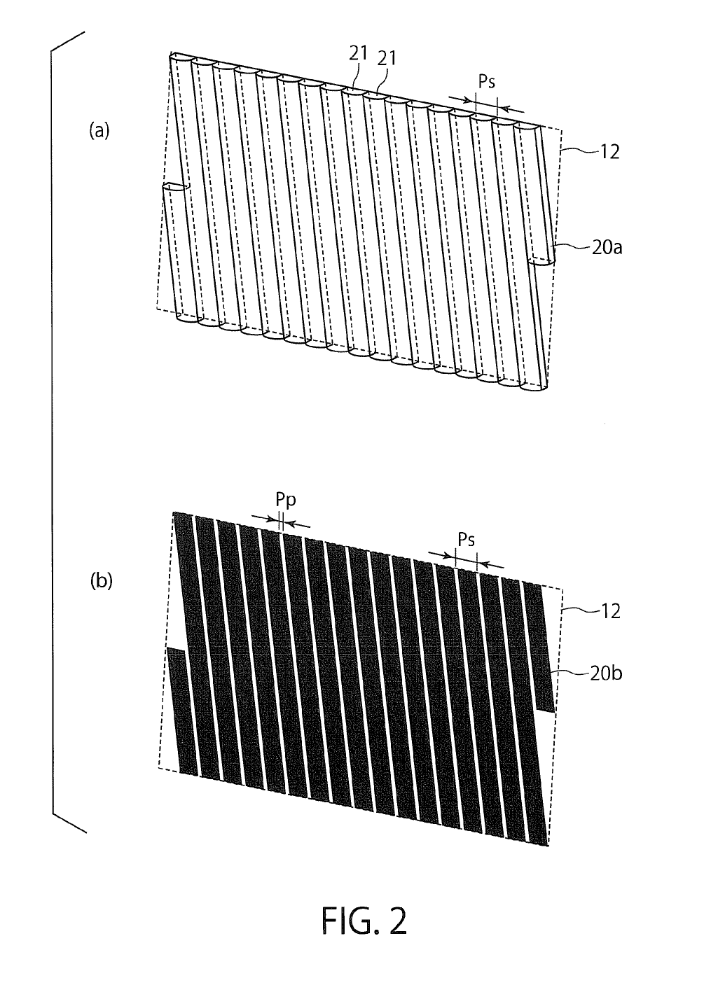

Furthermore, the stereoscopic video display apparatus according to the first embodiment has a configuration in which the direction of extension of the optical aperture portions in the optical plate 20 is inclined obliquely with respect to the longitudinal direction (column direction) of the display screen in the plane display unit 12. For example, FIG. 2(a) shows an oblique view in the case where the optical plate 20 is a lenticular sheet 20a formed of a plurality of cylindrical lenses 21, whereas FIG. 2(b) shows an oblique view in the case where the optical plate 20 is a slit 20b, In FIGS. 2(a) and 2(b), Ps denotes a pitch of the optical aperture portions in the optical plate 20. In FIG. 2(b), Pp denotes a size of an aperture portion of the slit.

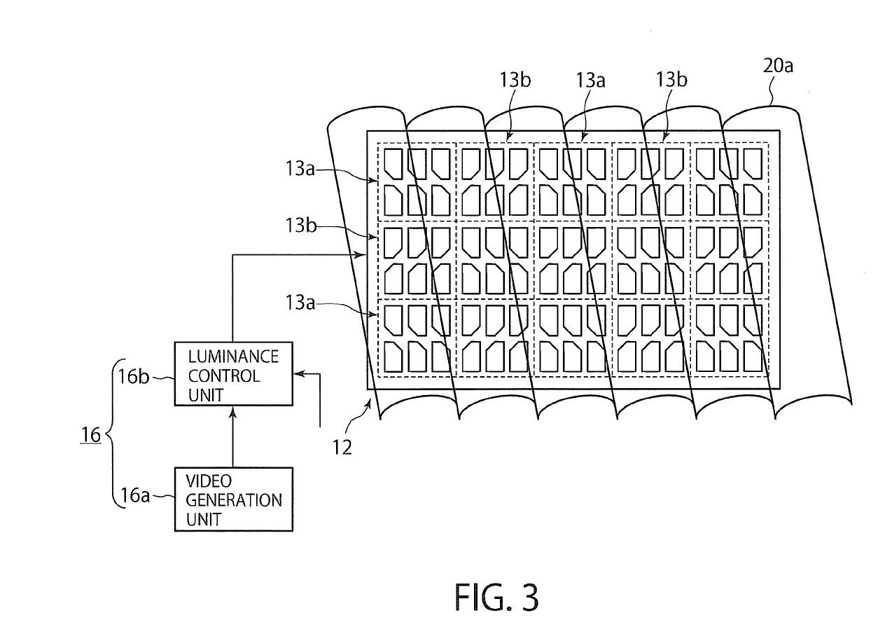

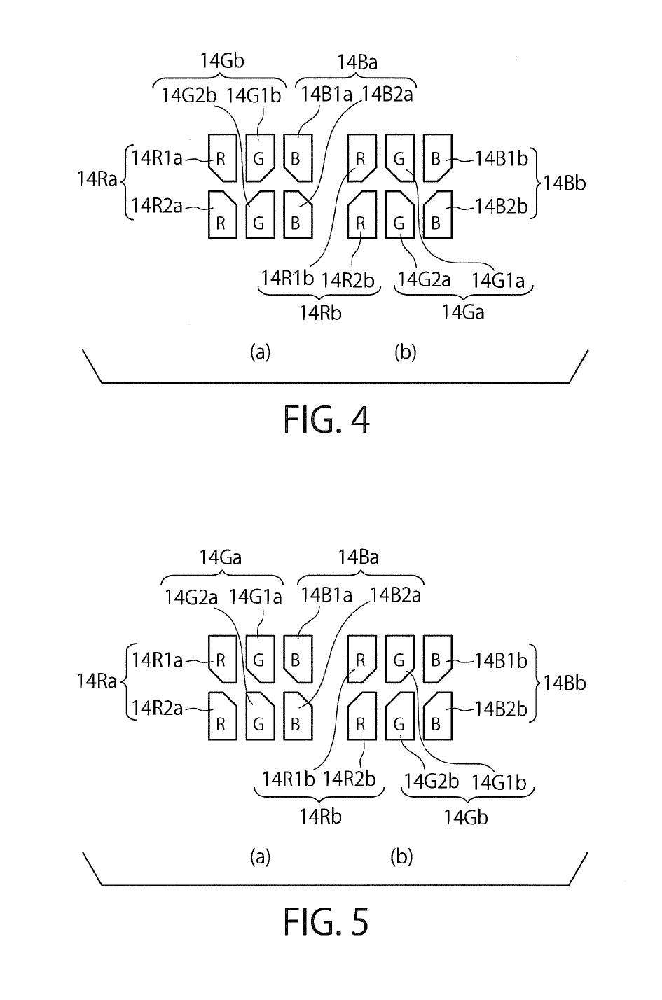

In the stereoscopic video display apparatus according to the first embodiment, the display screen in the plane display unit 12 has a configuration in which the first pixels 13a and the second pixels 13b are arranged alternately in a longitudinal direction and a lateral direction (row direction) as shown in FIG. 3. By the way, FIG. 3 shows an example in which the lenticular sheet 20a is used as the optical plate 20. FIGS. 4(a) and 4(b) show a first concrete example of the first and second pixels 13a and 13b, respectively.

As shown in FIG. 4(a), the first pixel 13a in the first concrete example includes sub-pixels 14Ra, 14Gb and 14Ba of R (red), G (green) and B (blue), respectively. Each sub-pixel has a configuration in which the length in the lateral direction is shorter than the length in the longitudinal direction. Each sub-pixel is divided into two portions having an equal area in the longitudinal direction of the display screen. For example, the sub-pixel 14Ra includes a first sub-pixel portion 14R1a located on an upper side and a second sub-pixel portion 14R2a located on a lower side. The first and second sub-pixel portions 14R1a and 14R2a are equal in area to each other. The first sub-pixel portion 14R1a has a cutout in its lower left corner, and the second sub-pixel portion 14R2a has a cutout in its upper right corner.

The sub-pixel 14Gb includes a first sub-pixel portion 14G1b located on an upper side and a second sub-pixel portion 14G2b located on a lower side. The first and second sub-pixel portions 14G1b and 14G2b are equal in area to each other. The first sub-pixel portion 14G1b has a cutout in its lower right corner, and the second sub-pixel portion 14G2b has a cutout in its upper left corner.

The sub-pixel 14Ba includes a first sub-pixel portion 14B1a located on an upper side and a second sub-pixel portion 14B2a located on a lower side. The first and second sub-pixel portions 14B1a and 14B2a are equal to each other in area. The first sub-pixel portion 14B1a has a cutout in its lower left corner, and the second sub-pixel portion 14B2a has a cutout in its upper right corner.

In other words, in the first pixel 13a in the first concrete example, cutout places in the sub-pixel of R are opposite to those in the sub-pixel of G, and the cutout places in the sub-pixel of G are opposite to those in the sub-pixel of B. In other words, the cutout places in the sub-pixel of R are the same as those in the sub-pixel of B.

As shown in FIG. 4(b), the second pixel 13b in the first concrete example includes sub-pixels 14Rb, 14Ga and 14Bb of R (red), G (green) and B (blue), respectively. Each sub-pixel is divided into two portions having an equal area in the longitudinal direction of the display screen. For example, the sub-pixel 14Rb includes a first sub-pixel portion 14R1b located on an upper side and a second sub-pixel portion 14R2b located on a lower side. The first and second sub-pixel portions 14R1b and 14R2b are equal to each other in area. The first sub-pixel portion 14R1b has a cutout in its bottom right corner, and the second sub-pixel portion 14R2b has a cutout in its left top corner.

The sub-pixel 14Ga includes a first sub-pixel portion 14G1a located on an upper side and a second sub-pixel portion 14G2a located on a lower side. The first and second sub-pixel portions 14G1a and 14G2a are equal to each other in area. The first sub-pixel portion 14G1a has a cutout in its bottom left corner, and the second sub-pixel portion 14G2a has a cutout in its right top corner.

The sub-pixel 14Bb includes a first sub-pixel portion 14B1b located on an upper side and a second sub-pixel portion 14B2b located on a lower side. The first and second sub-pixel portions 14B1b and 14B2b are equal to each other in area. The first sub-pixel portion 14B1b has a cutout in its bottom right corner, and the second sub-pixel portion 14B2b has a cutout in its left top corner.

Furthermore, in the second pixel 13b in the first concrete example, cutout places in the sub-pixel of R are opposite to those in the sub-pixel of G, and the cutout places in the sub-pixel of G are opposite to those in the sub-pixel of B, in the same way as the first pixel 13a in the first concrete example. In other words, the cutout places in the sub-pixel of R are the same as those in the sub-pixel of B. However, a sub-pixel of one color in the first pixel 13a in the first concrete example is different in cutout position from a sub-pixel of the corresponding color in the second pixel 13b in the first concrete example. Therefore, the first and second pixels 13a and 13b in the first concrete example are equal to each other in area, but are different from each other in shape.

FIGS. 5(a) and 5(b) show a second concrete example of the first and second pixels 13a and 13b, respectively. As shown in FIG. 5(a), the first pixel 13a in the second concrete example includes sub-pixels 14Ra, 14Ga and 14Ba of R (red), G (green) and B (blue), respectively. As shown in FIG. 5(b), the second pixel 13b in the second concrete example includes sub-pixels 14Rb, 14Gb and 14Bb of R (red), G (green) and B (blue), respectively. The sub-pixels of R, G and B in the first pixel 13a in the second concrete example are the same in cutout position, and the sub-pixels of R, G and B in the second pixel 13b in the second concrete example are the same in cutout position. However, a sub-pixel of one color in the first pixel 13a in the second concrete example is different in cutout position from a sub-pixel of the corresponding color in the second pixel 13b in the second concrete example. In the second concrete example as well as the first concrete example, the first and second pixels 13a and 13b in the second concrete example are equal to each other in area, but are different from each other in shape.

By the way, in the present embodiment, the display screen has a configuration in which the pixels 13a and 13b of two kinds having equal areas and different shapes are disposed alternately. In the case where the panel is a liquid crystal panel, such a configuration brings about an advantage that the viewing angle can be widened. Furthermore, the display screen can have a configuration in which pixels of three kinds or more having equal areas and different shapes are disposed alternately. In this case as well, the viewing angle can be widened if the panel is a liquid crystal panel.

In a stereoscopic video display apparatus in which the lengthwise direction of the optical plate 20 is disposed to be inclined with respect to the longitudinal direction of the plane display unit 12 having such a display screen, a shade of color occurs when a stereoscopic video is displayed and the same color is displayed on the display screen. In the first embodiment, therefore, the luminance control unit 16b exercises control to provide the first pixel 13a and the second pixel 13b which are adjacent to each other with different luminance values even if videos generated by the video generation unit 16a are video signals of the same color. A change quantity of luminance values for each of the first pixel 13a and the second pixel 13b differs depending upon the position of the pixel on a liquid crystal panel or the gray scale level of the color of the video signal which is input. Furthermore, if the refractive index of the optical plate can be changed, the luminance value of the first pixel 13a and the second pixel 13b is changed only when conducting stereoscopic video display. The luminance value of the first pixel 13a and the second pixel 13b is not changed when conducting two-dimensional video display.

Hereafter, a concrete method for changing the luminance will be described.

(1) When controlling the luminance, the total quantity of luminance over the whole screen is not changed. For example,

a) control is exercised to make an average value of luminance value of the first pixel 13a and the second pixel 13b equal to the luminance value of the screen obtained before the luminance is changed. In the case where the luminance of the first pixel 13a has been raised, therefore, the luminance of the second pixel 13b is lowered to make the average value of luminance after the control equal to that before the control.

b) When changing the control quantity of luminance depending upon coordinates or the gray scale level of color on the display panel, operation is conducted to make an average value of luminance of pixels which are adjacent to each other coincide with an average value of the original luminance.

By the way, in either case, the change quantity of luminance differs depending upon the position of the pixels on the liquid crystal panel and the gray scale level of color of the video signal which is input.

(2) When controlling the luminance depending upon the gray scale level of color, a method of a) or b) described hereafter is used.

a) At a middle gray scale level, control is exercised to maximize the difference in luminance between the first pixel and the second pixel. For this purpose, luminance of a pixel before the luminance change is conducted by the luminance control unit is set as described hereafter. It is now supposed that one pixel is formed of six sub-pixel portions as shown in FIGS. 4(a), 4(b) or FIGS. 5(a), 5(b). For example, when the gray scale level of a video signal which is input is equal to half of a maximum gray scale level Imax, for example, three upper sub-pixel portions in one pixel are set equal to the maximum gray scale level Imax and three lower sub-pixel portions are set equal to a minimum gray scale level (=0). If the gray scale level of the video signal which is input is greater than Imax/2, the three upper sub-pixel portions in one pixel are set equal to the maximum gray scale level Imax and the gray scale level of the three lower sub-pixel portions are set to cause an average value of this gray scale level and the maximum gray scale level Imax to become the gray scale level of the video signal which is input. In other words, in this case, the gray scale level of the three lower sub-pixel portions becomes a value obtained by subtracting the maximum gray scale level Imax from twice the gray scale level of the video signal which is input.

If the gray scale level of the video signal which is input is less than Imax/2, the three lower sub-pixel portions in one pixel are set equal to the minimum gray scale level and the gray scale level of the three upper sub-pixel portions are set to cause an average value of this gray scale level and the minimum gray scale level Imin to become the gray scale level of the video signal which is input. In other words, in this case, the gray scale level of the three upper sub-pixel portions becomes twice the gray scale level of the video signal which is input.

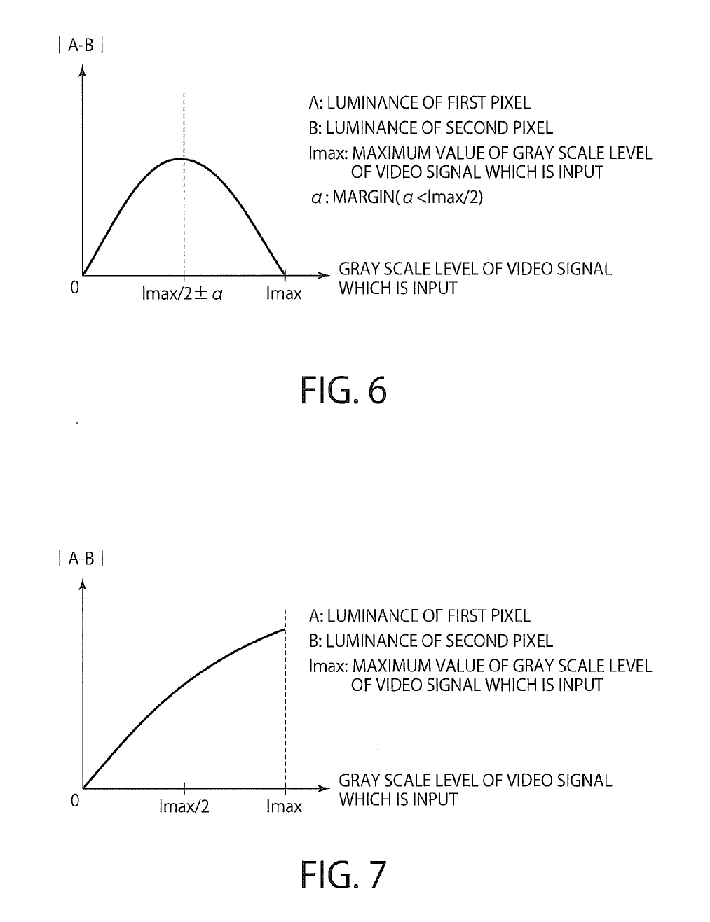

In this way, the luminance control unit sets the luminance of the pixel before the luminance of the pixel is changed. The luminance is changed by the luminance control unit to meet characteristics shown in FIG. 6 depending upon the gray scale level of the video signal which is input. In FIG. 6, the abscissa axis indicates the gray scale level of the video signal which is input, and the ordinate axis indicates |A-B| where A is the gray scale level of the first pixel 13a and B is the gray scale level of the second pixel 13b. As can be seen from FIG. 6, the difference in luminance between the first pixel and the second pixel after the change is maximized when the gray scale level of the video signal which is input is equal to Imax/2±α. Here, α represents a margin. When α is zero, the difference between the first pixel and the second pixel is maximized at half of Imax.

By the way, the maximum value of the characteristics shown in FIG. 6 becomes a value of Imax or less. The luminance control unit exercises control to cause the average luminance value of the first pixel and the second pixel before the change and the average luminance value of the first pixel and the second pixel after the change to become equal to each other. Furthermore, the change quantity of the luminance is set in a range in which the viewer cannot visually recognize color unevenness. In general, this adjustment is conducted before shipping the stereoscopic video display apparatus. By the way, the change quantity of the luminance may be made adjustable by the viewer via a remote controller after the shipping.

b) At the maximum gray scale level, control is exercised to maximize the difference in luminance between the first pixel and the second pixel. For this purpose, luminance of a pixel before the luminance change is conducted by the luminance control unit is set as described hereafter. For example, if one pixel is formed of six sub-pixel portions as shown in FIGS. 4(a), 4(b) or FIGS. 5(a), 5(b), all of the six sub-pixel portions are set to become the gray scale level of the video signal which is input.

In this way, the luminance control unit sets the luminance of the pixel before the luminance of the pixel is changed. The luminance is changed by the luminance control unit to meet characteristics shown in FIG. 7 depending upon the gray scale level of the video signal which is input. In FIG. 7, the abscissa axis indicates the gray scale level of the video signal which is input, and the ordinate axis indicates |A-B| where A is the gray scale level of the first pixel 13a and B is the gray scale level of the second pixel 13b. As can be seen from FIG. 7, the difference in luminance between the first pixel and the second pixel after the change is maximized when the gray scale level of the video signal which is input is equal to the maximum gray scale level Imax. By the way, the maximum value of the characteristics shown in FIG. 7 becomes a value of Imax or less. The luminance control unit exercises control to cause the average luminance value of the first pixel and the second pixel before the change and the average luminance value of the first pixel and the second pixel after the change to become equal to each other. Furthermore, the change quantity of the luminance is set in a range in which the viewer cannot visually recognize color unevenness. In general, this adjustment is conducted before shipping the stereoscopic video display apparatus. By the way, the change quantity of the luminance may be made adjustable by the viewer via a remote controller after the shipping.

According to the first embodiment, it is possible to reduce the influence of color unevenness and display a stereoscopic image which is a good display quality by exercising control to provide pixels which are the same in area, different in shape, and adjacent to each other with different luminance values even if the gray scale level of the video signal which is input is the same, as described heretofore.

In the first embodiment, an example shown in FIGS. 4(a), 4(b) or FIGS. 5(a), 5(b) has been mentioned as an example of pixels having an equal area and different shapes. However, the example is not restricted to them.

### Second Embodiment

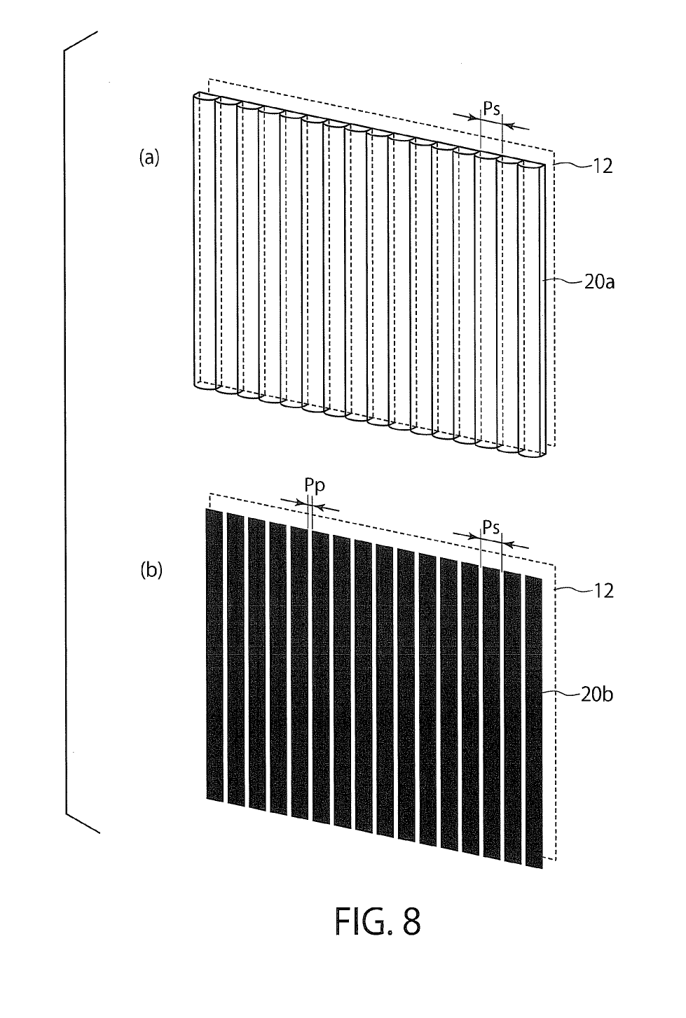

A stereoscopic video display apparatus according to a second embodiment will now be described with reference to FIGS. 8(a) and 8(b). In the stereoscopic video display apparatus according to the first embodiment, the stereoscopic video display apparatus according to the second embodiment has a configuration in which the direction of extension of the optical aperture portions in the optical plate 20 is inclined obliquely with respect to the longitudinal direction (column direction) of the display screen in the plane display unit 12. In the second embodiment, the stereoscopic video display apparatus has the same configuration as that in the first embodiment except that the direction of extension of the optical aperture portions in the optical plate 20 is made parallel to the longitudinal direction (column direction) of the display screen in the plane display unit 12. FIGS. 8(a) and 8(b) show examples of the optical plate 20 used in the stereoscopic video display apparatus according to the second embodiment. For example, FIG. 8(a) shows an oblique view in the case where the optical plate 20 is a lenticular sheet 20a formed of a plurality of cylindrical lenses 21, and FIG. 8(b) shows an oblique view in the case where the optical plate 20 is a slit 20b. In FIGS. 8(a) and 8(b), Ps denotes a pitch of the optical aperture portions in the optical plate 20. In FIG. 8(b), Pp denotes a size of an aperture portion of the slit.

In the stereoscopic video display apparatus according to the second embodiment as well, it is possible to reduce the influence of color unevenness and display a stereoscopic image which is a good display quality.

While certain embodiments have been described, these embodiments have been presented by way of example only, and are not intended to limit the scope of the inventions. Indeed, the novel methods and systems described herein can be embodied in a variety of other forms; furthermore, various omissions, substitutions and changes in the form of the methods and systems described herein can be made without departing from the spirit of the inventions. The accompanying claims and their equivalents are intended to cover such forms or modifications as would fall within the scope and spirit of the inventions.

What is claimed is:

1. A stereoscopic video display apparatus comprising:
a plane display device having a display face in which a first pixel and a second pixel having an equal area and different shapes are arranged alternately in a row direction and a column direction;
an optical plate disposed in front of the display face of the plane display device to control directions of light rays illuminated from the plane display device;
a video generation unit configured to generate a video for stereoscopic image display and a video for two-dimensional image display from a video signal which is input; and
a luminance control unit configured to change luminance values of the first and second pixels which are adjacent to each other when displaying the video generated by the video generation unit and exercise control to cause an average luminance of the first pixel and the second pixel before the change and an average luminance of the first pixel and the second pixel after the change to become equal to each other.

2. The stereoscopic video display apparatus according to claim 1, wherein a change quantity of luminance of the first and second pixels is set on the basis of positions of the first pixel and the second pixel on the display face and a gray scale level of the video signal which is input.

3. The stereoscopic video display apparatus according to claim 1, wherein the luminance control unit exercises control to maximize a difference in luminance between the first and second pixels at a gray scale level near a middle point.

4. The stereoscopic video display apparatus according to claim 1, wherein the luminance control unit exercises control to maximize a difference in luminance between the first and second pixels at a maximum gray scale level.

5. The stereoscopic video display apparatus according to claim 1, wherein when the video generated by the video generation unit is a video for stereoscopic video display, the luminance control unit exercises control to change luminance values of the first and second pixels.

6. The stereoscopic video display apparatus according to claim 1, wherein
each of the first and second pixels has red, green and blue sub-pixels,
each sub-pixel takes a shape in which a length in a row direction is shorter than a length in a column direction, and each sub-pixel is divided into a first portion and a second portion which are equal in area to each other and the area respectively located on an upper side and a lower side in the column direction,
the first portion located on the upper side in each sub-pixel has a cutout in a lower left corner or a lower right corner, and the second portion located on the lower side has a cutout in an upper right corner or an upper left corner,
the first and second portions in the same sub-pixel are different in cutout position in the row direction, and
a cutout position of a sub-pixel in the first pixel and a cutout position of a sub-pixel in the second pixel having the same color as the sub-pixel in the first pixel are opposite to each other.

7. The stereoscopic video display apparatus according to claim 1, wherein
the optical plate is a lenticular sheet having a plurality of lenses, a ridgeline of each of the lenses extending in a first direction and the lenses being arranged side by side in a second direction perpendicular to the first direction, and
in each of the lenses, the first direction is inclined with respect to the column direction of the display face.

8. The stereoscopic video display apparatus according to claim 1, wherein
the optical plate is a lenticular sheet having a plurality of lenses, a ridgeline of each of the lenses extending in a first direction and the lenses being arranged side by side in a second direction perpendicular to the first direction, and
the lenses are arranged in such a manner that the first direction becomes parallel to the column direction of the display face.

9. A stereoscopic video display method for displaying a stereoscopic video by using a stereoscopic video display apparatus including a plane display device having a display face in which a first pixel and a second pixel having an equal area and different shapes are arranged alternately in a row direction and a column direction, and an optical plate disposed in front of the display face of the plane display device to control directions of light rays illuminated from the plane display device, the stereoscopic video display method comprising:
generating a video for stereoscopic image display and a video for two-dimensional image display from a video signal which is input; and
changing luminance values of the first and second pixels which are adjacent to each other when displaying the generated video and exercising control to cause an average luminance of the first pixel and the second pixel before the change and an average luminance of the first pixel and the second pixel after the change to become equal to each other.
